(19) United States
(12) Patent Application Publication
(10) Pub. No.: US 2026/0025312 A1
(43) Pub. Date: Jan. 22, 2026

(54) DISPARATE RENEWABLE POWER ENERGY SOURCED SERVER NODES

(71) Applicant: INTERNATIONAL BUSINESS MACHINES CORPORATION, ARMONK, NY (US)

(72) Inventors: Abhishek Jain, Baraut (IN); Siddhartha Sood, Ghaziabad (IN); Rachana Vishwanathula, Hyderabad (IN)

(21) Appl. No.: 18/773,708

(22) Filed: Jul. 16, 2024

(51) Int. Cl. H04L 41/0816; G06Q 30/018; H04L 41/0823; H04L 41/22; H04L 67/1012

(52) U.S. Cl. CPC H04L 41/0816; G06Q 30/018; H04L 41/0836; H04L 67/1012; H04L 41/22

(57) ABSTRACT

According to one embodiment, a method, computer system, and computer program product for managing a computer network based on energy sources powering nodes of the computer network is provided. The present invention may include identifying the power source powering each of the nodes comprising the computer network; calculating a carbon footprint associated with the nodes of the computer network based on the power source; receiving a sustainability goal from the client; provisioning one or more nodes of the computer network based on the sustainability goal and the carbon footprint associated with the nodes; and managing a workload of the client based on the sustainability goal and the carbon footprint associated with the nodes.

### BACKGROUND

The present invention relates, generally, to the field of computing, and more particularly to network management.

The field of network management is the technical field concerned with managing the ever-increasing complexity of computer networks. Since the inception of the wide-area packet-switched network, computer networks have exploded in size and sophistication well beyond that which any human administrator could manage manually; network management software became a necessity for operating and maintaining large computer networks. Network management software collects information about the devices that make up the network, called nodes, and presents that data to network administrators in an accessible and easy-to-understand format. Network management software may further assist in provisioning new devices in the network environment, discovering the features of the network, monitoring the network for problems, and suggesting improvements, ensuring that the network configuration is correct and that there is no configuration drift, ensuring compliance with regulatory standards and enterprise goals, and many other vital administrative tasks.

### SUMMARY

According to at least one embodiment, a method, computer system, and computer program product for managing a computer network based on energy sources powering nodes of the computer network is provided. The present invention may include identifying the power source powering each of the nodes comprising the computer network; calculating a carbon footprint associated with the nodes of the computer network based on the power source; receiving a sustainability goal from the client; provisioning one or more nodes of the computer network based on the sustainability goal and the carbon footprint associated with the nodes; and managing a workload of the client based on the sustainability goal and the carbon footprint associated with the nodes.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a sustainable network management process according to at least one embodiment;

FIG. 3 illustrates an exemplary networked computing environment comprising a heterogeneous datacenter according to at least one embodiment; and

FIG. 4 illustrates an exemplary networked computing environment comprising homogeneous datacenters according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to network management. The following described exemplary embodiments provide a system, method, and program product to, among other things, provision and manage a network based on the energy sources powering individual nodes of the network so as to maintain client sustainability goals.

As previously described, the field of network management is the technical field concerned with managing the ever-increasing complexity of computer networks. One objective of network management is to ensure that the network complies with goals set by the managing organization. One increasingly relevant goal that enterprises are striving to achieve is that of sustainability; public/private cloud solution providers are increasingly seeking to mix energy from renewable sources into the power budget of their facilities, including datacenters, to meet carbon emission goals. Likewise, consumers of cloud services are increasingly taking carbon emissions statistics and renewable energy usage into account when considering potential cloud solutions, as they attempt to meet their own sustainability goals; cloud solutions deployed in datacenters powered by renewable power sources such as wind and solar may become increasingly desirable over datacenters powered by fossil fuels.

Data centers are usually powered by energy from the electrical grid. An electrical grid may be an interconnected network for electricity delivery, from generation to transmission to consumption. An electrical grid may range in size from a microgrid to a wide-area synchronous grid to a super grid. A microgrid may be a small electrical network scaled to power an individual building, a campus comprising several buildings, or a community, and may be designed to operate in isolation from a larger electrical grid; a wide-area synchronous grid may operate at a regional scale or greater and may comprise multiple microgrids; and a super grid may be trans-continental or multinational in scale, and may comprise multiple wide-area synchronous grids. Wide-area synchronous grids and super grids may be divided into any number of subregions. An electrical grid may be powered by one or more power stations, which may generate power from any number or combination of sources including coal, petroleum, natural gas, geothermal, hydroelectricity, nuclear, solar, wind, et cetera. Every type of energy has its own energy intensity which defines how many carbon equivalents that energy type emits, with fossil fuels being the highest, and renewable energy sources. However, in general, the more renewable energy used, the lower the quantity of carbon emitted into the atmosphere, and the more sustainable the solution is. Conversely, the more non-renewable energy used, the higher the quantity of carbon emitted into the atmosphere, and the less sustainable the solution is. Nuclear energy is an exception to this rule, as it is not renewable, but has a much lower carbon footprint than other non-renewable energy sources. To calculate the sustainability of a solution as a scope-1 metric, the energy on which a network solution is running may be taken into consideration and the respective carbon emissions that are released may be calculated based on the energy that is being consumed.

Datacenters are power hungry facilities, and an unplanned loss of power can result in consequences ranging in severity from unplanned downtime to loss or theft of business data and customer data to overheating of data center electrical infrastructure. As such, many cloud service providers already pursue limited onsite generation capabilities such as diesel generators, to augment grid power or replace it in the event of a power outage. Increasingly, however, cloud service providers are seeking to meet climate goals as well as power needs by adding renewable onsite generation capabilities such as solar panels and wind turbines, with the result that cloud service providers may power their datacenters using a mix of energy from one or more sources in addition to, and in rare cases, instead of, power from the electrical grid. However, managing power from different sources is challenging, as it requires onsite infrastructure to allocate power from the multiple power sources among the components of the datacenter. Methods have been developed in the art to address this challenge and dynamically allocate power from multiple sources to run the workload on a server, resulting in the creation of heterogeneous platforms, or datacenters that receive power from one or more power sources in addition (or alternatively to) power from an electrical grid. Current implementations of heterogeneous platforms can vary significantly with respect to power characteristics and power management capabilities.

However, despite these advancements enabling cloud service providers to incorporate multiple types of energy in powering their datacenters, there is as yet no means by which cloud consumers may leverage these advances to access and use the nodes of such datacenters based on the type of energy powering the nodes in service of their own sustainability goals. Despite the general and increasing focus on sustainability, most cloud providers and enterprises are prioritizing the following aspects of sustainability, specifically for compute centric workloads: 1) right sizing, or continually analyzing instance performance and usage needs and patterns, and dynamically adjusting the size and performance characteristics of the cloud to match the workload and eliminate waste; 2) leveraging FinOps key performance indicators (KPIs) to collaboratively control cloud costs; 3) selecting the right hardware and processors to match the workload; 4) selecting cloud architecture to maximize the user experience at the front end of the cloud computing solution while also optimizing back-end operations with servers, solutions, and storage; 5) auto-scaling, or adding or subtracting instances to match the workload, et cetera. The focus for sustainability “in” the cloud is primarily left to the customer and application team, and as a result, advancements facilitating the sustainability goals of cloud consumers have been commensurately fewer and farther between; As such, there is no proactive approach in the art for matching a customer-driven desired sustainability state as compute is provisioned. In other words, there exists no technique which can enable cloud consumers to use renewable-energy-powered server nodes from a heterogeneously powered datacenter in a heterogeneous distributed cluster environment to meet their customer's application carbon footprint goals. Furthermore, there is currently no application placement framework which considers the type of energy powering these heterogeneously powered nodes, and by extension the carbon emissions associated with the node, when allocating workload among the nodes to meet sustainability goals.

As such, it may be advantageous to, among other things, implement a system comprising a number of nodes that are distributed within multiple datacenters powered by various energy sources, and where the system allocates client workloads amongst the nodes based on the energy sources powering the nodes and the associated carbon emissions, in order to meet clients' sustainability goals. Additionally, it may further be advantageous to implement a sustainable auto-scaling system that, upon predicting that scaling is required for a client workload, automatically selects nodes for provisioning based on the energy sources powering the nodes and the anticipated resulting carbon emissions, so as to keep carbon emissions within the client's sustainability goals. Therefore, the present embodiment has the capacity to improve the technical field of network management by providing a distributed cluster offering an unprecedentedly granular per-node assessment of node power source and resulting carbon emissions, as opposed to a per-datacenter assessment, and managing workload among the nodes to automatically maintain carbon emissions resulting from the client workload at or below a sustainability goal set by the client, even when scaling network capacity to address increased demand from the client. Present embodiments empower clients to exert a level of control over their cloud-based environmental impact that no current methods can match, which in turn enables clients to reduce their cloud-based carbon emissions and meet sustainability goals which heretofore may have been outside of their control.

According to an aspect of the invention, there is provided a processor-implemented method for managing a computer network based on energy sources powering nodes of the computer network, the method comprising: identifying one or more power sources powering each of the nodes comprising the computer network; calculating a carbon footprint associated with the nodes of the computer network based on the power source; receiving a sustainability goal; provisioning one or more nodes of the computer network based on the sustainability goal and the carbon footprint associated with the nodes; and managing a workload of a client based on the sustainability goal and the carbon footprint associated with the nodes. This aspect of the invention identifies power sources of the nodes of a computer network, and provisions and manages a workload of a client on the computer network based on the sustainability goal and the power sources, enabling individual clients to directly take advantage of energy sources available to a network in a granular per-node fashion to ensure that their sustainability goals are met, and that the workloads the client deploys to the cloud do not exceed a maximum environmental impact set by the client.

According to an aspect of the invention, there is provided a computer system for managing a computer network based on energy sources powering nodes of the computer network, the computer system comprising: a computer network comprising one or more nodes, one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising: identifying one or more power sources powering each of the nodes comprising the computer network; calculating a carbon footprint associated with the nodes of the computer network based on the power source; receiving a sustainability goal; provisioning one or more nodes of the computer network based on the sustainability goal and the carbon footprint associated with the nodes; and managing a workload of a client based on the sustainability goal and the carbon footprint associated with the nodes. This aspect of the invention identifies power sources of the nodes of a computer network, and provisions and manages a workload of a client on the computer network based on the sustainability goal and the power sources, enabling individual clients to directly take advantage of energy sources available to a network in a granular per-node fashion to ensure that their sustainability goals are met, and that the workloads the client deploys to the cloud do not exceed a maximum environmental impact set by the client.

According to an aspect of the invention, there is provided a computer program product for managing a computer network based on energy sources powering nodes of the computer network, the computer program product comprising: one or more computer-readable tangible storage medium and program instructions stored on at least one of the one or more tangible storage medium, the program instructions executable by a processor to cause the processor to perform a method comprising: identifying one or more power sources powering each of the nodes comprising the computer network; calculating a carbon footprint associated with the nodes of the computer network based on the power source; receiving a sustainability goal; provisioning one or more nodes of the computer network based on the sustainability goal and the carbon footprint associated with the nodes; and managing a workload of a client based on the sustainability goal and the carbon footprint associated with the nodes. This aspect of the invention identifies power sources of the nodes of a computer network, and provisions and manages a workload of a client on the computer network based on the sustainability goal and the power sources, enabling individual clients to directly take advantage of energy sources available to a network in a granular per-node fashion to ensure that their sustainability goals are met, and that the workloads the client deploys to the cloud do not exceed a maximum environmental impact set by the client.

In embodiments, the invention further comprises scaling a size of the computer network by provisioning or deprovisioning nodes of the computer network based on the power source of the nodes and the sustainability goal. By enabling scaling of the size of the network based on the power source of the nodes and the sustainability goal, such embodiments of the invention provide client workloads the flexibility to scale up or down in size while adhering to the sustainability goal, improving the flexibility of the inventive system by improving its ability to handle inconsistent workloads, and decreasing the environmental impact and operating costs of the inventive system itself without compromising client sustainability goals by enabling the system to deprovision nodes that are not needed based on the environmental impact.

In embodiments, the identifying further comprises retrieving a power mix for one or more grid-powered nodes comprising the nodes, and wherein the calculating for the grid-powered nodes is based on the power mix. Such embodiments extend the inventive system's advantages in sustainably managing a network based on power sources and sustainability goals to nodes which are powered by the grid; ordinarily the environmental impact of such nodes would be impossible to determine due to the many power sources contributing to any given electrical grid, but by ascertaining the power mix for a grid-powered node, the inventive system is able to approximate a carbon footprint of a node.

In embodiments, the managing is based on a real-time availability of renewable power sources. Such embodiments improve the accuracy of the inventive system's determination of the power source of a node and management based on that determined power source by maintaining an up-to-date record of how much renewable power is powering the nodes; because renewable energy ebbs and flows into the system as the result of local weather conditions, time of day, available sunlight, et cetera, a static or rarely-updated record of available renewable power may, for example, falsely represent a node as powered by solar energy at midnight, when in fact no solar power is being generated and the node is entirely powered from the electrical grid.

In embodiments, the invention further comprises displaying a visualization of the computer network to the client, wherein the visualization displays the power source of the nodes. Such embodiments further empower a client to take advantage of available power sources by providing up-to-date information on the available power sources of the individual nodes of the network and enabling the client to make informed decisions and enter instructions regarding a client sustainability goal.

In embodiments, the sustainability goal comprises a network sustainability goal. Such embodiments allow an entity or organization running the network to manage the network according to internal sustainability goals, alternatively or in addition to the sustainability goals of clients.

According to an alternative aspect of the invention, there is provided a processor-implemented method for managing a computer network based on energy sources powering nodes of the computer network, the method comprising: for each of one or more grid-powered nodes of the one or more nodes comprising the computer network, identifying a power mix of an electrical grid or subregion of the electrical grid where the grid-powered node is located, where the power mix comprises a proportion of all energy sources that provide electricity to the subregion; calculating a carbon footprint associated with the grid-powered nodes of the computer network based on the power mix; receiving a sustainability goal; provisioning one or more nodes of the computer network based on the sustainability goal and the carbon footprint associated with the grid-powered nodes; and managing a workload of the client based on the sustainability goal and the carbon footprint associated with the grid-powered nodes.

References in the specification to “one embodiment”, “other embodiment”, “another embodiment”, “an embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying”, “atop”, “over”, “on”, “positioned on” or “positioned atop” mean that a first element is present on a second element wherein intervening elements, such as an interface structure, may be present between the first element and the second element. The term “direct contact” means that a first element and a second element are connected without any intermediary conducting, insulating, or semiconductor layers at the interface of the two elements.

In the interest of not obscuring the presentation of the embodiments of the present invention, in the following detailed description, some of the processing steps, materials, or operations that are known in the art may have been combined together for presentation and for illustration purposes and in some instances may not have been described in detail. Additionally, for brevity and maintaining a focus on distinctive features of elements of the present invention, description of previously discussed materials, processes, and structures may not be repeated with regard to subsequent Figures. In other instances, some processing steps or operations that are known may not be described. It should be understood that the following description is rather focused on the distinctive features or elements of the various embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to provision and manage a network based on the energy sources powering individual nodes of the network so as to maintain client sustainability goals.

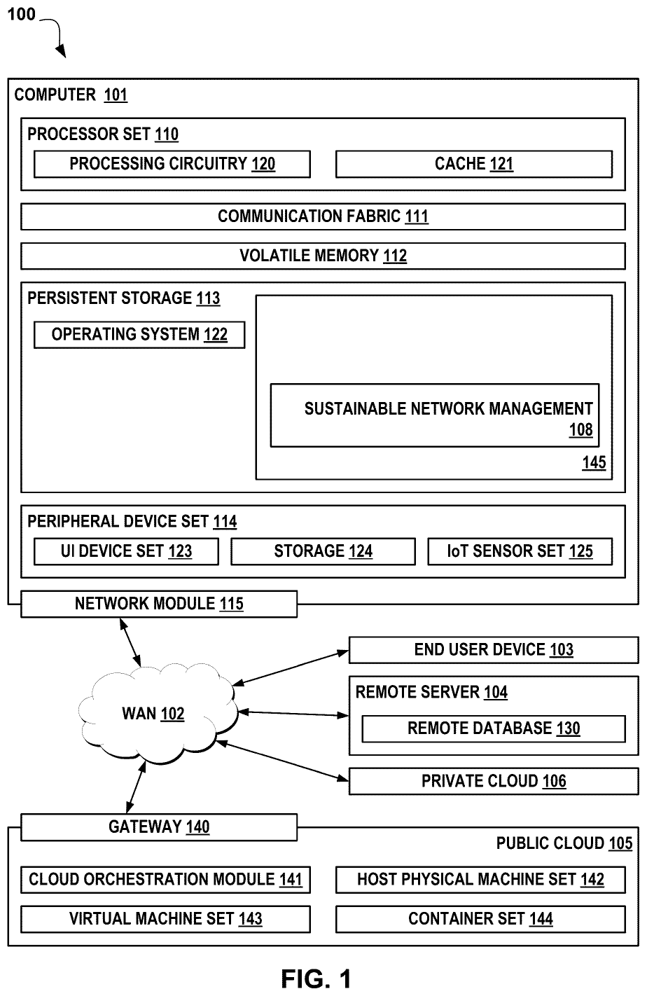

Referring now to FIG. 1, computing environment 100 contains an example of an environment for the execution of at least some of the computer code involved in performing the inventive methods, such as code block 145, which may comprise sustainable network management program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

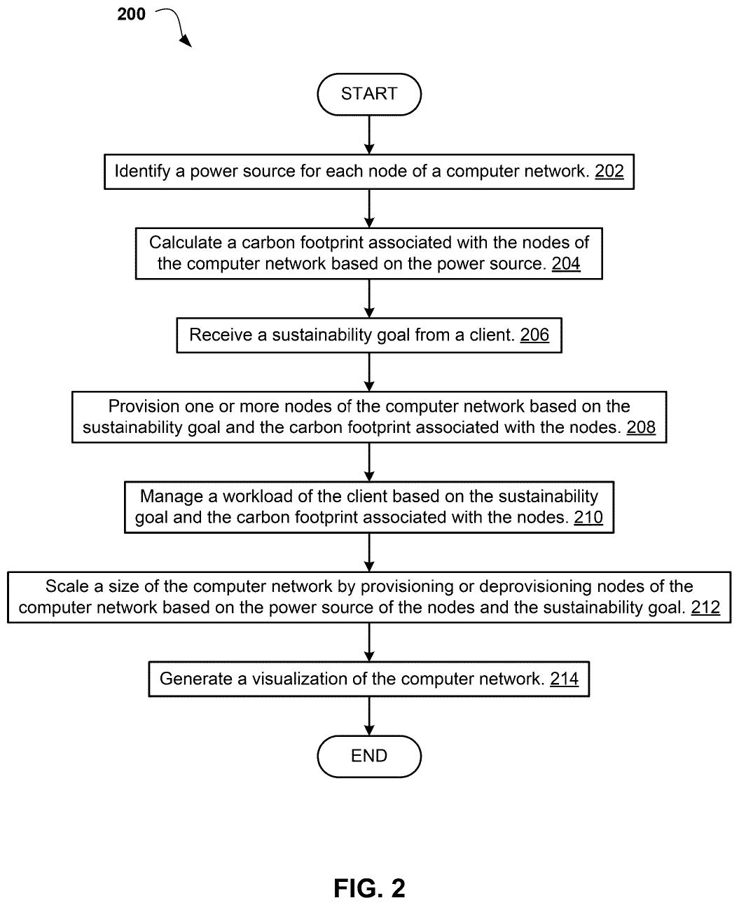

According to the present embodiment, the sustainable network management program 108 may be a program enabled to provision and manage a network based on the energy sources powering individual nodes of the network so as to maintain client sustainability goals. The sustainable network management program 108 may be a software cluster manager such as a Kubernetes® node manager (Kubernetes and all Kubernetes-based trademarks and logos are trademarks or registered trademarks of The Linux Foundation and/or its affiliates). The sustainable network management program 108 may, when executed, cause the computing environment 100 to carry out a sustainable network management process 200. The sustainable network management process 200 may be explained in further detail below with respect to FIG. 2. In embodiments of the invention, the sustainable network management program 108 may be stored and/or run within or by any number or combination of devices including computer 101, end user device 103, remote server 104, private cloud 106, and/or public cloud 105, peripheral device set 114, and volatile memory 112 and/or on any other device connected to WAN 102. Furthermore, sustainable network management program 108 may be distributed in its operation over any number or combination of the aforementioned devices.

Referring now to FIG. 2, an operational flowchart illustrating a sustainable network management process 200 is depicted according to at least one embodiment. At 202, the sustainable network management program 108 may identify a power source for each node of a computer network. The computer network, or distributed network, may be a distributed cloud network comprising multiple nodes that may be physically disparate, for example located within two or more separate datacenters, but which communicate with each other and with sustainable network management program 108 to allocate workloads amongst the various nodes and execute processes in a distributed fashion. For example, the computer network may be a highly available MZR (Multi Zone Region) cluster with a standard 3×3 node configuration; 3 nodes per AZ, and 3 AZ. In embodiments of the invention, when provisioning, or initializing, new nodes into the distributed network, the sustainable network management program 108 may identify an energy source powering the node, such that the sustainable network management program 108 keeps track of which nodes are powered by which energy source.

The sustainable network management program 108 may identify the power source for each node by first determining whether a datacenter hosting the node is heterogeneous or homogeneous; a datacenter is homogeneous when it receives electricity from only one source, such as the electrical grid, and may be heterogeneous when it receives electricity from two or more separate sources, such as the electrical grid and a geothermal power generator. The sustainable network management program 108 may identify a datacenter associated with a node, for example by parsing a node configuration file to extract physical and/or logical address information of the node, and may query an entity responsible for managing power allocation, which may vary in complexity from a network manager or a power controller node to one or more automatic transfer switches (ATCs) or one or more power distribution units (PDUs), to determine whether the datacenter is powered by one power source or multiple.

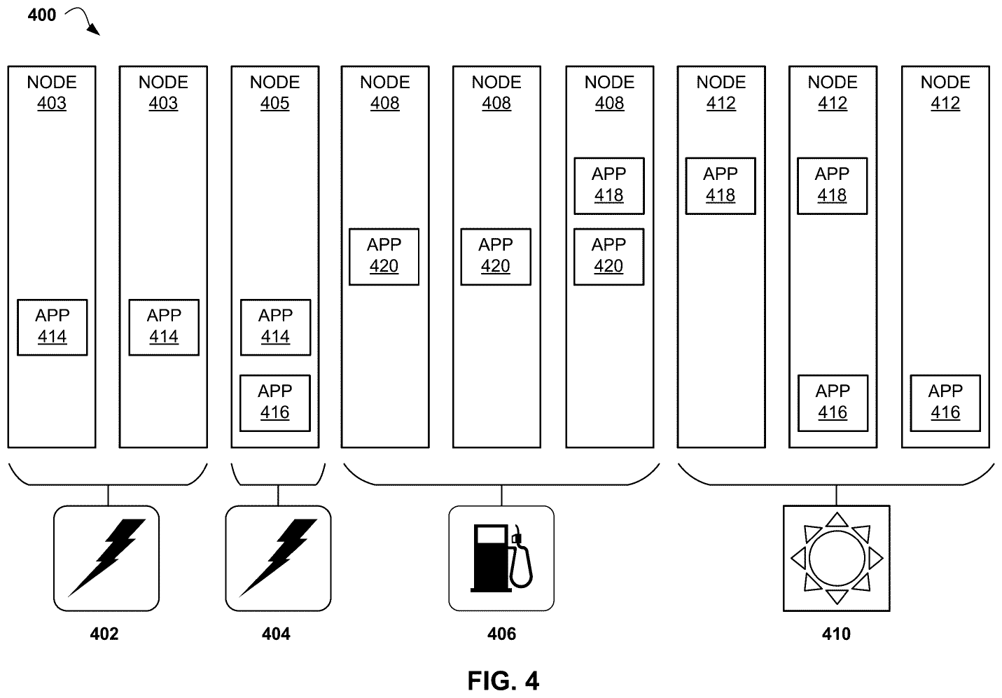

Responsive to determining that the datacenter is powered by one power source, or, in other words, is a homogenous datacenter, the sustainable network management program 108 may query the entity responsible for managing power allocation in the datacenter to determine what power source powers the datacenter. The sustainable network management program 108 may presume all nodes in the datacenter share the same power source. Identifying the power source of nodes in homogeneous datacenters may be discussed in further detail below with respect to FIG. 4.

Responsive to determining that the datacenter is powered by two or more power sources, or, in other words, is a heterogeneous datacenter, the sustainable network management program 108 may determine the power sources of nodes on a per-node basis. In a heterogeneous datacenter, at least two of the nodes are powered by different energy sources, and any given node may be receiving power from any one or multiple of the at least two power sources supplying the heterogenous data center. Therefore, the sustainable network management program 108 may communicate with the entity responsible for managing power allocation, to determine power allocation to the individual node, and/or to a rack hosting the node if power allocation to the individual node is unavailable; the node may be presumed to have the same power source as the rack holding it. Identifying the power source of nodes in a heterogeneous datacenter may be discussed in further detail below with respect to FIG. 4.

In embodiments of the invention, for example where the node is completely or partially powered from an electrical grid, such as by a utility substation, the sustainable network management program 108 may identify a power mix associated with a regional electrical grid and/or one or more subregions of an electrical grid where the grid-powered node is located and which the grid-powered node is being powered from. The sustainable network management program 108 may identify a geographical location of the grid-powered node, and/or the datacenter where the grid-powered node is located, from, for example, a configuration file, or by querying a network manager or other administrative entity associated with the datacenter of the grid-powered node. The sustainable network management program 108 may compare the location of the grid-powered node or datacenter against a map of the electrical grids and/or subregions of the electrical grids local to the grid-powered node or datacenter, which may be retrieved from or accessed at an external service or database. The sustainable network management program 108 may then retrieve a power mix for the electrical grid or subregion of the electrical grid local to the grid-powered node or datacenter of the grid-powered node. The power mix may be retrieved from an external service or database, such as the United States Environmental Protection Agency (EPA) Emissions & Generation Resource Integrated Database (eGRID). The power mix may be a list of all power sources that provide power to the electrical grid or subregion, and the percentage that each such power source contributes to the total power generation of the electrical grid or subregion. For example, for a given subregion, a power mix might comprise 25% coal, 35% petroleum, 26% natural gas, and 14% nuclear energy.

In embodiments, once the sustainable network management program 108 has identified a power source for a node, the sustainable network management program 108 may record the power source on a power supply marker uniquely associated with the node. The power supply marker may denote a type of energy powering the node, or in other words the method or source by which the energy powering the node was generated, which may be any one of hydroelectric, coal, oil, solar, wind, geothermal, nuclear, tidal, et cetera. The power supply marker may further denote whether the type of energy powering the node is renewable. For example, a node may be marked as “powersupply=renewable/wind” or “powersupply=utility,” etc. In embodiments, a physical node server management entity may communicate with a server-rack-based power source controller of each node to identify the power source powering the node and may record the power source on the power supply marker; the physical node server management entity may then carry-forward the power supply marker to the sustainable network management program 108 to label each node with respective power supply. In embodiments, for example when the node is powered from the grid, the sustainable network management program 108 may label the node with the power mix of the electrical grid or subregion that the node is drawing power from. In embodiments, once a power source has been identified for any given node, the sustainable network management program 108 may continue to reascertain the energy source powering the nodes at regular intervals to track the energy sources of the network's component nodes in real-time or near-real-time, to account for fluctuations in power source caused by, for example, the waxing and waning of available renewable power sources resulting from environmental conditions, and to allocate workloads between the nodes based on the sometimes mercurial availability of renewable power sources. In such cases, the sustainable network management program 108 may dynamically update the power supply marker to reflect the current power supply of the associated node.

At 204, the sustainable network management program 108 may calculate a carbon footprint associated with the nodes of the computer network based on the power source. The sustainable network management program 108 may store and maintain, or retrieve on demand, a carbon intensity database pairing each of a list of power sources with the carbon intensity attributed to that power source. The carbon intensity may be a measurement of the number of units of carbon or carbon equivalents which are emitted into the atmosphere for each unit of power produced via a particular source. For example, the list may read as follows: [wind, 26], [solar, 48], [nuclear, 29], [hydroelectricity, 26], [geothermal, 38], [fossil, 635], [natural_gas, 743], [petroleum, 816], [coal, 995]. The sustainable network management program 108 may periodically update the carbon intensity database with new information from an external source to ensure accuracy. The sustainable network management program 108 may maintain a node power consumption database pairing each node in the network with a power consumption associated with that node, where the power consumption is the number of units of power consumed by the node during operation. The power consumption for a node may vary as the result of a number of variables, such as a load placed on the node, an age of the node, a temperature of the node, et cetera, and in some cases the sustainable network management program 108 may tracked and predict the power consumption for the node based on observed trends. The sustainable network management program 108 may receive the power consumption from an external source such as a marketing website, a performance database, the manufacturer, a user, et cetera, and/or may be updated or otherwise based on actual power consumption of the node as observed by the sustainable network management program 108 under different circumstances during the period of operation of the node, and/or may be updated or otherwise based on an actual power consumption of equivalent nodes as observed by the sustainable network management program 108, where equivalent nodes may be other nodes that currently or formerly comprised the network that are of the same model as the node. The sustainable network management program 108 may calculate the carbon footprint associated with each node by multiplying the power consumption of the node by the carbon intensity of the energy source powering the node to calculate the carbon footprint associated with the node. In embodiments where a node is powered by a two or more different sources, the sustainable network management program 108 may ascertain, from the entity responsible for managing power allocation within the datacenter, what percentage of power comes from each source, and may calculate a combined carbon footprint representing the carbon footprint of each of the component power sources. In embodiments, the sustainable network management program 108 may calculate the carbon footprint associated with the node based on variables currently affecting the node or variables predicted to affect the node, such as drops or rises in temperature in the datacenter, current or anticipated load, et cetera. In embodiments, for example where the node is powered by the grid, the sustainable network management program 108 may calculate a carbon footprint associated with the node by calculating the carbon footprint associated with each power source powering the node in proportion to the amount that such power source contributes to the total power consumption of the node, based on the power mix. The sustainable network management program 108 may add together the carbon footprints of each component power source to create a total carbon footprint for the node.

At 206, the sustainable network management program 108 may receive a sustainability goal from a client. The sustainability goal may be a list of parameters or rules governing the provisioning and management of the client's workload in the computer network with respect to the carbon emissions generated by the nodes allocated to the client. The sustainability goal may comprise a maximum carbon emissions limit which may be per cluster or per application, which represents a threshold of carbon emission that must not be exceeded to successfully meet the client's sustainability goals. In embodiments, the client may define the desired carbon limits along with the usual definitions such as hardware configuration, region, etc. In some embodiments, instead of setting a carbon limit, the client may alternately select the preferred power source of the data center where the nodes are provisioned, and/or may specify how many nodes are to be powered by specific power sources. For example, the sustainable network management program 108 may prompt a cloud consumer to define how many cluster nodes should be deployed on hardware powered with solar energy and how many should be deployed on hardware powered by fossil fuel energy along with their CO2 data. In embodiments, the sustainable network management program 108 may have the ability to prioritize certain energy sources higher than others depending on their availability; for example, based on the client sustainability goal, the sustainable network management program 108 may prioritize hardware energy source preferences with appropriate floor and ceiling limits. In another example, the client may specify that of the nodes allocated to the client's workload, three of the nodes must be powered by coal, three nodes by hydro, and three nodes by geothermal for a given sustainability goal.

In some alternative embodiments of the invention, the sustainable network management program 108 may receive a network sustainability goal from a cluster administrator associated with the computer network, which may comprise sustainability goals applying to the distributed network itself. The network sustainability goal may specify whether it applies to the cluster as a whole or to one or more individual applications (currently deployed or to be deployed in the future), required nodes to be deployed in executing an application, and the energy source the nodes are to be powered by (coal, petroleum, natural gas, geothermal, hydroelectricity, nuclear, solar, wind etc.). These network sustainability goals may also be determined dynamically based on historical data of the cluster nodes' power consumption and application carbon emission generation analysis. In such embodiments, the sustainable network management program 108 may carry out all steps of the inventive method as herein described, but where the sustainable network management program 108 provisions one or more nodes of the computer network, manages a workload of a client, and/or scales a size of the computer network based on the network sustainability goal instead of or in addition to the client sustainability goals.

At 208, the sustainable network management program 108 may provision one or more nodes of the computer network based on the sustainability goal and the carbon footprint associated with the nodes. Provisioning a node may entail installing an operating system and various files required for the node to function as part of the distributed network onto the node, and then adding the node to the distributed network; in embodiments of the invention, provisioning may further entail selecting nodes to provision based on the power source associated with the node and the client sustainability goals associated with workloads to be allocated to the node; in other words, the sustainable network management program 108 may first assess a client sustainability goal associated with a workload that requires scaling; based on the parameters of the client sustainability goal, and an extent to which the goal is currently being met with respect to the rest of the client's workload within the distributed network (for example, the difference between the carbon footprint currently generated by the client's workload and the maximum carbon footprint specified by the client sustainability goal), the sustainable network management program 108 may identify all available nodes and/or all combinations of available nodes that, if provisioned and allocated with the scaled portion of the client's workload, would generate a carbon footprint that, when combined with the carbon footprint generated with that of the other nodes processing the client's workload, would still be low enough to fall within the parameters of the sustainability goal. Once the electricity is determined for the carbon limits set, the sustainable network management program 108 may provision nodes on the respective datacenters powered by electricity from a source that does not contribute enough to the carbon footprint to exceed the carbon limit. For example, where the client has set a sustainability goal of no more than 150 units of carbon produced for a 1×6 cluster, the sustainable network management program 108 may determine the power source or power sources on which the nodes should be deployed to meet the 150-unit carbon limit. In some embodiments, for example where instead of setting a carbon limit, the client may alternately select the preferred power source of the data center where the nodes are provisioned, the sustainable network management program 108 may provision the nodes on the respective datacenters that are powered by the power source selected by the client. As an example, if the client sets a sustainability goal comprising 3 nodes on coal, 3 nodes on hydro, and 3 nodes on geothermal, the sustainable network management program 108 will provision the first trio of nodes on a coal-powered datacenter, the second trio of nodes on a hydroelectric powered datacenter, and the third trio of nodes on a geothermally powered datacenter.

At 210, the sustainable network management program 108 may manage a workload of the client based on the sustainability goal and the carbon footprint associated with the nodes. Once the distributed computer network is created and workloads are already deployed on the nodes of the distributed computer network in accordance with the defined client sustainability goals, the sustainable network management program 108 may manage the distributed network. In other words, the sustainable network management program 108 may operate, maintain, administer, and secure infrastructure of the distributed network. In managing the distributed network, the sustainable network management program 108 may scale nodes of the network up or down to match the size and capability of the cluster to the predicted and/or currently deployed workload; the sustainable network management program 108 may scale the cluster node up or down by allocating computing resources on the provisioned nodes based on the energy source powering those nodes, so as to maintain compliance with the sustainability goal. For example, if a client sustainability goal specifics that the client workload achieve a certain minimum carbon footprint, and the client workload must be scaled up, the sustainable network management program 108 may allocate additional resources in a node powered by geothermal energy to ensure that the client workload does not exceed the minimum carbon footprint. In embodiments, for example where the sustainable network management program 108 dynamically tracks the power sources powering the nodes, the sustainable network management program 108 may shift workloads between the nodes as the amount of renewable energy powering one or more nodes shifts. For example, as night falls, the amount of solar energy available to power a datacenter might decrease, such that nodes powered purely by solar may be powered by an increasing proportion of energy from the power grid; the sustainable network management program 108 may recognize the increasing carbon footprint associated with client workloads performed on such nodes, and may allocate workloads away from that node and initialize resources on other renewably-powered nodes, such as wind-powered nodes or solar powered nodes in regions that are still experiencing daylight, so as to maintain compliance with the client sustainability goals. In embodiments, the sustainable network management program 108 may anticipate the availability of certain desired energy sources powering the nodes of the distributed network and may pre-emptively allocate workloads around the network in response. For example, the sustainable network management program 108 may retrieve weather information from a weather forecasting service or application to determine weather conditions in the surrounding environments of one or more datacenters where the nodes are located and predict the availability of renewable energy sources based on the weather conditions. For example, the sustainable network management program 108 may retrieve predicted wind speed over time and may calculate the amount of wind energy generated by wind turbines powering one or more nodes and may allocate workloads to or from wind-powered nodes based on the predicted availability of renewable wind energy.

While managing the workload of the client, there may arise situations where the number or combination of resources on provisioned nodes available to be allocated to a client's workload is insufficient for compliance with the client sustainability goal. In such embodiments, the sustainable network management program 108 may provision new nodes to meet the demands of the client's sustainability goal. However, if no new nodes are available to be provisioned that would meet the client's sustainability goal, the sustainable network management program 108 may inform the client of the break in compliance and may dynamically monitor the availability of nodes and node resources so as to bring the client workload back to the desired sustainability state as soon as the nodes or node resources necessary for compliance are available.

At 212, the sustainable network management program 108 may scale a size of the computer network by provisioning or deprovisioning nodes of the computer network based on the power source of the nodes and the sustainability goal. When existing resources on already-provisioned nodes of the distributed network are insufficient to meet the resource demands of the client workloads, and/or are insufficient to maintain compliance with the parameters of the client sustainability goals, sustainable network management program 108 may dynamically provision new nodes to assume operation of at least part of the client workload and address the shortfall. Here, when the sustainable network management program 108 determines that a client application running on the computer network is expected to scale, the sustainable network management program 108 may provision a node to deploy the new portions of the client workload to that is powered by an energy source with a carbon intensity low enough to maintain compliance with the client sustainability goal. For example, if the net carbon limit set forth in the client sustainability goal is 10 CO2 equivalents, the client workload currently has a carbon footprint of 8 CO2 equivalents, and the client workload is being scaled, the sustainable network management program 108 may deploy the new portions of the client workload only on nodes powered with solar, as that is the only power source with a low enough carbon footprint to meet the client sustainability goal.

When the client workload has diminished such that one or more nodes are not being used, the sustainable network management program 108 may deprovision unused nodes to reduce the costs of operating the distributed network and spare the machines from wasted cycles, wasted power, and unnecessary wear. The sustainable network management program 108 may in embodiments, select nodes to deprovision based on the energy source powering the node; for example, the sustainable network management program 108 may prioritize nodes for deprovisioning based on the carbon intensity of the power sources powering the nodes, such that when the client workload has contracted enough that a single node worth of workload or more is unused, the sustainable network management program 108 may select a node powered by an energy source with the highest associated carbon intensity of the currently provisioned nodes in the network, allocate the selected node's workloads to other nodes, subject of course to the restrictions of the relevant client sustainability goals, and deprovision the selected node.

At 214, the sustainable network management program 108 may generate a visualization of the computer network wherein each node of the network is depicted along with the power source or power sources powering each of the nodes. The power sources may be listed alongside graphical representations of the nodes, may be accessible in a window that may be opened by clicking on or mousing over the graphical representations of the nodes, may be represented by graphical icons positioned adjacent to the graphical representations of the nodes, et cetera. The graphical representations of the nodes may range in color from green to red based on a carbon footprint associated with the node, with green representing a low carbon footprint and red representing a high carbon footprint. The visualization may graphically represent workloads and/or containers of workloads associated with a given client and the nodes to which they are currently assigned. The visualization may comprise a visual element representing compliance with a client sustainability goal; for example, a widget on the visualization may comprise a text box that reads “met” or “not met” depending on the current status of the client sustainability goal. In embodiments, a client may interact with the visualization to directly enter or modify parameters of a client sustainability goal and may select power sources or nodes for sustainable network management program 108 to prioritize allocating workloads to by clicking on graphical representations of nodes and/or graphical representations of power sources. The sustainable network management program 108 may dynamically update the visualization in real time such that the visualization represents an accurate, up-to-date record of the nodes, the power sources, and/or the workloads. In embodiments, the sustainable network management program 108 may display the visualization on a display screen of UI device set 123 on a computer 101, for instance a mobile device, associated with a client.

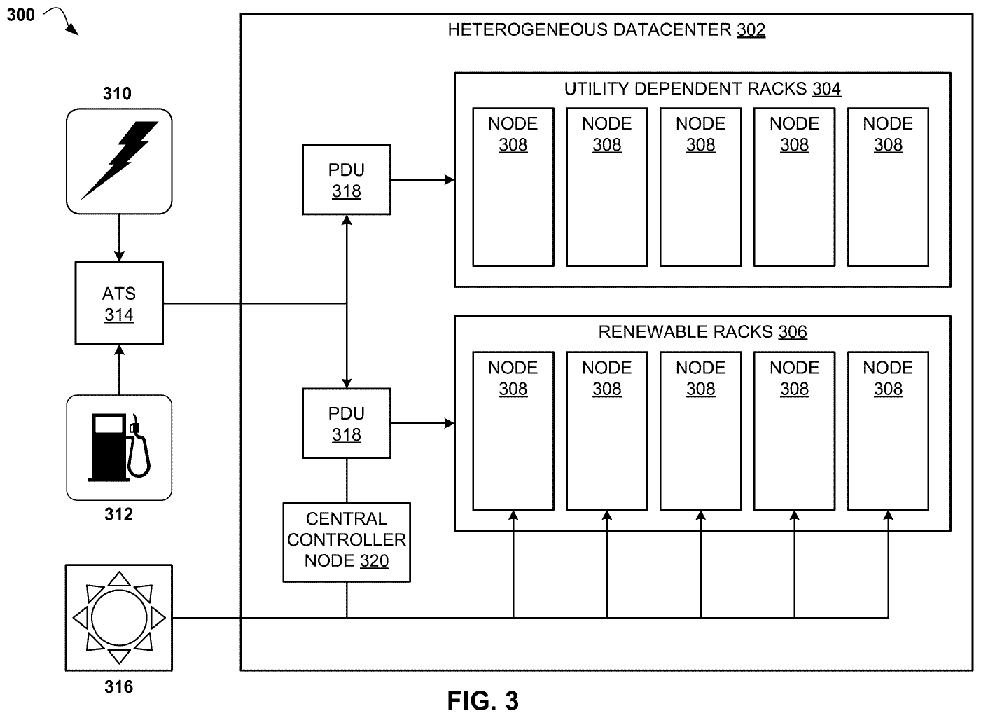

Referring now to FIG. 3, an exemplary networked computing environment 300 comprising a heterogeneous datacenter 302 is depicted, according to at least one embodiment. Here, a heterogeneous datacenter 302 comprises utility dependent racks 304 and renewable racks 306, which each comprise a number of nodes 308. The heterogeneous datacenter 302 receives power from utility substation 310, which is in turn connected to the regional electrical grid. The heterogenous datacenter 302 is also connected to a diesel backup generator 312, which may be activated when power is no longer provided through utility substation 310, such as during a power outage. The heterogeneous datacenter 302 may further be powered by an on-site solar array 316. The utility substation 310 and the diesel backup generator 312 are connected to ATS 314, or automatic transfer switch 314, which may be a self-acting power switching device governed by a dedicated control logic. The purpose of the ATS 314 is to ensure the continuous delivery of electrical power to the heterogeneous datacenter from the two power sources. The ATS 314 may seek connection to the primary power source (the utility substation 310) by default and may only connect to the alternate power source (diesel backup generator 312) when required to do so due to primary source failure, or when requested to do so via operator command. The ATS 314 may provide power to one or more PDUs 318, or power distribution units 316, which may be devices fitted with multiple outputs designed to distribute electric power to the nodes 308 of the utility dependent racks 304 and the renewable racks 306 of the heterogeneous datacenter 301. The PDUs 318 may receive power from both the ATS 314 and the solar array 316 via separate input lines and may be capable of allocating power from the ATS 314 or the solar array 316 to the utility dependent racks 304, to the renewable racks 306, to individual nodes 308, and/or may be capable of allocating a mixture of power from both sources to any given node 308 or rack. The PDUs 318 and the ATS 314 may be controlled and coordinated by a central controller node 320, which may use predictive scheduling to anticipate the fluctuations in input power received from the solar array 316 over the course of the day, and may anticipate the power consumption of the nodes 308 based on predicted or observed workload, and may allocate power from the ATS 314 and the solar array 316 accordingly. Here, the solar array 316 is directly connected to the nodes 308 of the renewable racks 306, which may be equipped with batteries to store power from the solar array 316 so that they can continue to run off of solar energy even when the sun is obscured or set, until the batteries run out. In embodiments, the solar array 316 may be connected to a separate battery bank which is in turn connected to the renewable racks 306. Input power from the solar array 316 may be controlled and allocated by the PDUs 318, which may in turn be controlled by the central controller node 320. The heterogeneous datacenter 302 may be heterogeneous because it runs off of power from two power sources at the same time: the utility substation 310, and the solar array 316. Because the diesel backup generator 312 is only turned on to replace missing power from the utility 310 and does not provide power during regular operation of the heterogeneous datacenter 302, it does not contribute to the heterogeneous status of the heterogeneous datacenter 302. The utility dependent racks 304 may be primarily allocated power from the utility substation 310, and the renewable racks 306 may be primarily allocated power from the solar array 316. However, the renewable racks 306 may be run on power from the utility 310 if the solar array 316 provides insufficient power and may be run on power from the diesel backup generator 312 in the event of a power outage. Conversely, the utility dependent racks 304 may be run on power from solar array 316 if solar array 316 is providing power beyond what is required to power renewable racks 306.

In embodiments of the invention, for example where the sustainable network management program 108 is provisioning one or more nodes 308 on utility dependent racks 304 and/or on renewable racks 306, the sustainable network management program 108 may identify a power source of the nodes 308. The sustainable network management program 108 may communicate with the central controller node 320 to first determine whether the power supply of the datacenter is homogeneous or heterogeneous; upon ascertaining that the data center is heterogeneous from the central controller node 320, the sustainable network management program 108 may request the current power supply and distribution throughout the heterogeneous datacenter 302. For example, the sustainable network management program 108 may request the physical location of the nodes 308 to be provisioned within the homogeneous datacenter 302, and may request data regarding the current power allocation to the racks where the nodes 308 are located; in response, the central controller node 320 may, for example, provide the information that a node 308 is located within a utility dependent rack 304, or a renewable rack 306, and that the node 308 is accordingly powered from the utility substation 310 or from the solar array 316, respectively. In embodiments, for example where the central controller node 320 allocates power on a per-node basis rather than a per-rack basis, the controller node 320 may respond with power allocation information for each of the individual nodes 308 to be provisioned.

In embodiments of the invention, for example where there is no central controller node 320 present within the heterogeneous datacenter 302, the sustainable network management program 108 may instead retrieve a location associated with a node 308 from, for example, a configuration file or by querying a network manager associated with the heterogeneous datacenter 302; the sustainable network management program 108 may then query the network manager, may query the ATS 314, or may query each PDU 318 or the PDU 318 associated with the rack where the node 308 is located to request the power allocation to the node 308's location.

In some embodiments, the sustainable network management program 108 may continue to request power allocation information from the central controller node 320, network manager, ATS 314 or PDU 318 at regular intervals to maintain an accurate real-time or near-real-time awareness of the power source or power sources powering each node 308 in the heterogeneous datacenter 302 that is associated with the sustainable network management program 108. In embodiments, the sustainable network management program 108 may ascertain predicted power supply and distribution throughout the heterogeneous datacenter 302 from the central controller node 320 based on predicted fluctuations in renewable energy supply and/or fluctuations in power consumption based on predicted resource loads; the sustainable network management program 108 may use such predicted power information to inform allocation of workloads to the nodes 308 associated with sustainable network management program 108.

Referring now to FIG. 4, an exemplary networked computing environment 400 comprising homogeneous datacenters is depicted, according to at least one embodiment. Here, three homogeneous datacenters are depicted: a first utility datacenter 402 comprising first grid nodes 403 which is powered purely by the regional power grid; a second utility datacenter 404 comprising second grid node 405 which is likewise purely powered by the regional power grid; a fossil fuels datacenter 406 comprising coal nodes 408 which is powered purely by fossil fuels; and a renewable datacenter 410 comprising solar nodes 412 which is powered purely by solar energy. First grid nodes 403, second grid node 405, coal nodes 408, and solar nodes 412 may all be part of the distributed cluster comprising sustainable network management program 108.

In embodiments of the invention, for example where the sustainable network management program 108 is provisioning one or more nodes on first utility datacenter 402, second utility datacenter 404, fossil fuels datacenter 406, and/or the renewable datacenter 410, the sustainable network management program 108 may identify a power source of the nodes 408. The sustainable network management program 108 may communicate with a central controller node of each datacenter to first determine whether the power supply of the datacenter is homogeneous or heterogeneous; upon ascertaining that the data center is heterogeneous from the central controller node, the sustainable network management program 108 may request the source of the power supply of the homogenous datacenter, and may label all nodes located within the homogenous datacenter as powered by the same energy source powering the homogeneous datacenter.

The workload currently being executed on the nodes of the datacenters comprises four programs: application 414, application 416, application 418, and application 420. Each application is owned by a separate client and governed by a separate sustainability goal, and, for case of illustration, each application is separated into three subprocesses, or containers, distributed across three separate nodes. For application 414, the associated client sustainability goal may specify that sustainable network management program 108 is to allocate none of the client's workload to coal nodes 408, and sustainable network management program 108 accordingly allocates all three subprocesses of application 414 to the first grid nodes 403 and second grid node 405. For application 416, the associated client sustainability goal may specify that the combined carbon footprint must fall below a threshold value, and sustainable network management program 108 has accordingly allocated two containers of application 416 to solar nodes 412 and one container to second grid node 405 to ensure the carbon footprint generated by the execution of application 416 falls below the specified threshold. For application 418, the associated client sustainability goal may specify that two containers must be allocated to nodes powered by renewable energy, and so sustainable network management program 108 accordingly allocates two containers to solar nodes 412. With respect to application 420, the client sustainability goal may set a very high threshold value for the carbon footprint generated by the execution of application 420, such that sustainable network management program 108 may allocate the workloads of application 420 to coal nodes 408 without exceeding the specified threshold. The sustainable network management program 108 may dynamically shift the workloads of the applications between the first grid nodes 403, the second grid node 405, the coal nodes 408, and the solar nodes 412 to maintain compliance with the client sustainability goals set forth by the applications' respective owners.

In an exemplary embodiment of the invention, sustainable network management program 108 may calculate a power mix associated with the subregion of an electrical grid powering first utility datacenter 402; the subregion of first utility datacenter 402 may be rocky and forested and predominantly powered by coal, such that the sustainable network management program 108 calculates that the subregion of the first utility datacenter 402 has a power mix that comprises 50% coal, 30% petroleum, 10% geothermal, and 10% hydroelectricity. The second utility datacenter 404 is powered by the same electrical grid as the first utility datacenter 402 but is located within a subregion of that electrical grid which comprises open plains and hills hosting multiple wind farms and solar arrays, such that the sustainable network management program 108 calculates the power mix to be comprises 25% wind, 25% solar, 30% coal, 10% geothermal, and 10% nuclear. The sustainable network management program 108 may calculate a carbon footprint for each of the two utility datacenters based on the power mixes. Because the carbon footprint of the power mix for the second utility datacenter 404 is substantially lower than the carbon footprint of the power mix for the first utility datacenter 402, the sustainable network management program 108 may allocate the workload of application 416 to the second grid node 405 of second utility datacenter 404 instead of allocating the workload to first grid nodes 403 of the first utility datacenter 402 in order to meet the client sustainability goals of the client who owns application 416, even though both the first utility datacenter 402 and the second utility datacenter 404 are both powered by the same electrical grid.

It may be appreciated that FIGS. 2-4 provide only illustrations of individual implementations and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for managing a computer network based on energy sources powering nodes of the computer network, the method comprising:
identifying one or more power sources powering each of the nodes comprising the computer network;
calculating a carbon footprint associated with the nodes of the computer network based on the one or more power sources;
receiving a sustainability goal;
provisioning one or more nodes of the computer network based on the sustainability goal and the carbon footprint associated with the nodes; and
managing a workload of a client based on the sustainability goal and the carbon footprint associated with the nodes.

2. The method of claim 1, further comprising:
scaling a size of the computer network by provisioning or deprovisioning the nodes based on the carbon footprint associated with the nodes and the sustainability goal.

3. The method of claim 1, wherein the identifying comprises retrieving a power mix for one or more grid-powered nodes comprising the nodes, and wherein the calculating for the grid-powered nodes is based on the power mix.

4. The method of claim 1, wherein the managing is based on a real-time availability of renewable power sources.

5. The method of claim 1, wherein the identifying further comprises:
responsive to determining that a node is in a heterogeneous datacenter, retrieving a power source from a power controller of the heterogeneous datacenter.

6. The method of claim 1, further comprising:
displaying a visualization of the computer network to the client, wherein the visualization displays the one or more power sources of the nodes.

7. The method of claim 1, wherein the sustainability goal comprises a network sustainability goal.

8. A computer system for managing a computer network based on energy sources powering nodes of the computer network, the computer system comprising:
a computer network comprising one or more nodes, one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying one or more power sources powering each of the nodes comprising the computer network;
calculating a carbon footprint associated with the nodes of the computer network based on the one or more power sources;
receiving a sustainability goal;
provisioning one or more nodes of the computer network based on the sustainability goal and the carbon footprint associated with the nodes; and
managing a workload of a client based on the sustainability goal and the carbon footprint associated with the nodes.

9. The computer system of claim 8, further comprising:
scaling a size of the computer network by provisioning or deprovisioning the nodes based on the carbon footprint associated with the nodes and the sustainability goal.

10. The computer system of claim 8, wherein the identifying comprises retrieving a power mix for one or more grid-powered nodes comprising the nodes, and wherein the calculating for the grid-powered nodes is based on the power mix.

11. The computer system of claim 8, wherein the managing is based on a real-time availability of renewable power sources.

12. The computer system of claim 8, wherein the identifying further comprises:
responsive to determining that a node is in a heterogeneous datacenter, retrieving a power source from a power controller of the heterogeneous datacenter.

13. The computer system of claim 8, further comprising:
displaying a visualization of the computer network to the client, wherein the visualization displays the one or more power sources of the nodes.

14. The computer system of claim 8, wherein the sustainability goal comprises a network sustainability goal.

15. A computer program product for managing a computer network based on energy sources powering nodes of the computer network, the computer program product comprising:
one or more computer-readable tangible storage medium and program instructions stored on at least one of the one or more tangible storage medium, the program instructions executable by a processor to cause the processor to perform a method comprising:
identifying one or more power sources powering each of the nodes comprising the computer network;
calculating a carbon footprint associated with the nodes of the computer network based on the one or more power sources;
receiving a sustainability goal;
provisioning one or more nodes of the computer network based on the sustainability goal and the carbon footprint associated with the nodes; and
managing a workload of a client based on the sustainability goal and the carbon footprint associated with the nodes.

16. The computer program product of claim 15, further comprising:
scaling a size of the computer network by provisioning or deprovisioning the nodes based on the carbon footprint associated with the nodes and the sustainability goal.

17. The computer program product of claim 15, wherein the identifying comprises retrieving a power mix for one or more grid-powered nodes comprising the nodes, and wherein the calculating for the grid-powered nodes is based on the power mix.

18. The computer program product of claim 15, wherein the managing is based on a real-time availability of renewable power sources.

19. The computer program product of claim 15, wherein the identifying further comprises:
responsive to determining that a node is in a heterogeneous datacenter, retrieving a power source from a power controller of the heterogeneous datacenter.

20. The computer program product of claim 15, further comprising:
displaying a visualization of the computer network to the client, wherein the visualization displays the one or more power sources of the nodes.
